(19) United States
(12) Patent Application Publication
(10) Pub. No.: US 2024/0172315 A1
(43) Pub. Date: May 23, 2024

(54) AUTOMATIC PAIRING RECOVERY BETWEEN ZIGBEE DEVICES

(71) Applicant: ARRIS Enterprises LLC, Suwanee, GA (US)

(72) Inventors: Bibin Balachandran, Kerala (IN); Akhil Poyya Raghavan, Kerala (IN); Anil H. Sanghavi, Westford, MA (US); Sanjay Gandotra, Santa Clara, CA (US)

(73) Assignee: ARRIS Enterprises LLC, Suwanee, GA (US)

(21) Appl. No.: 18/512,609

(22) Filed: Nov. 17, 2023

(30) Foreign Application Priority Data
Nov. 19, 2022 (IN) 202241066503

(51) Int. Cl. H04W 76/19; H04W 48/18

(52) U.S. Cl. CPC H04W 76/19; H04W 48/18

(57) ABSTRACT

During operation, the computer system (such as a controller) may receive, from an access point, information specifying an electronic device that has the connection with the access point. Then, based at least in part on the information, the computer system may store a mapping between the electronic device and the access point. Moreover, the computer system may receive, from the access point or a second access point, a notification message, where the notification message is associated with an orphan notification of the electronic device. Next, in response to receiving the notification message, the computer system may perform a look-up operation for the electronic device in the stored mapping. Furthermore, when the electronic device is included in the stored mapping, the computer system may selectively provide, to the access point and based at least in part on the stored mapping, second information specifying the electronic device.

### CROSS REFERENCE TO RELATED APPLICATIONS

This application claims priority under 35 U.S.C. 119(c) to Indian Provisional Application Serial Number 202241066503, “Automatic Pairing Recovery Between Zigbee Devices,” filed on Nov. 19, 2022, by Bibin Balachandran et al., the contents of which are herein incorporated by reference.

### FIELD

The described embodiments relate to techniques for automatically recovering a pairing between an access point and an electronic device.

### BACKGROUND

The increasing capabilities of electronic devices are dramatically changing our lives. For example, the processing and communication capabilities of portable electronic devices, such as cellular telephones, provide users with the capabilities of a handheld computer. In conjunction with expanded networks, such as the cellular-telephone networks and the Internet, these capabilities are allowing individuals to: access vast amounts of information; identify and interact with other people, organizations and governments; access information at arbitrary locations; and/or perform a wide variety of tasks. Collectively, these technologies have resulted in a significant increase in economic activity (such as online financial transactions, which are sometimes referred to as ‘ecommerce’) and productivity, and enable a host of applications that enhance user experiences and quality of life.

Recently, it has been proposed that further advances can be achieved by enhancing the capabilities of other electronic devices, which are pervasive but largely ignored by most users (such as in appliances, infrastructure, electronic locks, transportation, farming, etc.). Notably, by embedding sensors, actuators and communication capabilities in these ‘background’ electronic devices, the so-called ‘Internet of things’ (IoT) can provide a distributed network that facilities the exchange of data, remote sensing and control, and a diverse set of applications that facilitate more direct integration of the physical world into computer-based systems. In principle, the IoT offers the promise of highly automated systems that improve efficiency, enhance accuracy and expand economic activity in a diverse set of markets, such as: smart cities, hospitality, retail, education, housing, and manufacturing.

In practice, there are still obstacles to achieving the goals of the IoT. Notably, the IoT marketplace is diverse, with competing commercial entities offering devices/endpoints, networks, middleware and cloud-based platforms and services. Moreover, the marketplace lacks interoperability standards, which restricts communication and the exchange of data among components in these systems. The resulting lack of coordination can make it difficult to scale IoT systems while maintaining or ensuring quality of service.

Consequently, the IoT remains fragmented and siloed, which forces users to purchase additional dedicated equipment (such as separate gateways for electronic devices from different manufacturers and providers, and/or additional network switches to connect to different cloud-based service providers) in an attempt to build integrated solutions. However, these efforts often result in custom and expensive solutions with redundant equipment and limited flexibility, all of which is frustrating to users and limits market traction of the IoT.

Moreover, some electronic devices (such as electronic locks) communicate infrequently. These so-called ‘sleepy end devices’ may be dropped or disconnected from networks by gateway devices, such as access points. For example, after installing and joining or connecting a battery-powered electronic lock to an access point using a Zigbee communication protocol (from the Connectivity Standards Alliance of Davis, California), the electronic lock may transition to a sleep mode to conserve battery power. The electronic device may wake up occasionally to re-connect with the access point. Notably, when the access point receives such a communication from the electronic lock, the access point may perform a look-up operation in a connection or child table in the access point to confirm that the electronic lock is allowed to join a network.

However, when a battery failure occurs, the electronic device may not be able to communicate with the access point. If the communication between the electronic lock and the access point is not restored within 12 days, the access point may delete the electronic lock from the connection or child table. Therefore, the electronic lock may not be able to automatically rejoin the network even when communication by the electronic lock is restored, such as after a technician replaces the battery in the electronic lock. Instead, a network operator may need to manually rejoin or connect the electronic lock and the access point again. This network operator may be different from the technician that replaced the battery, because the technician may not have the required privileges to establish a connection or to join the electronic lock and the access point. Consequently, constraints associated with some communication protocols may increase the complexity and expense of the IoT, which may also be frustrating to users and may also limit market traction of the IoT.

### SUMMARY

A computer system that facilitates automatic recovery of a connection between an electronic device and an access point is described. This computer system includes: an interface circuit that communicates with the access point; a processor; and memory that stores program instructions. During operation, the computer system receives, associated with the access point, information specifying the electronic device that has the connection with the access point. Then, based at least in part on the information, the computer system stores a mapping between the electronic device and the access point. Moreover, the computer system receives, associated with the access point or a second access point, a notification message, where the notification message is associated with an orphan notification of the electronic device. Next, in response to receiving the notification message, the computer system performs a look-up operation for the electronic device in the stored mapping. Furthermore, when the electronic device is included in the stored mapping, the computer system selectively provides, addressed to the access point and based at least in part on the stored mapping, second information specifying the electronic device.

Note that the information and/or the second information may include an identifier of the electronic device. For example, the identifier may include a media access control (MAC) address of the electronic device.

Moreover, the orphan notification may occur when the electronic device and the access point are unable to automatically establish the connection.

Furthermore, the connection may allow the electronic device to join a network that includes the access point.

Additionally, the computer system may include a cloud-based computer system.

In some embodiments, the orphan notification may be associated with a Zigbee communication protocol.

Note that the electronic device may include an electronic lock.

Moreover, the computer system may include a controller of the access point.

Another embodiment provides the access point. The access point includes: an interface circuit that communicates with the electronic device and the computer system; a processor; and memory that stores program instructions. During operation, the access point establishes a connection with an electronic device and stores information specifying the electronic device in a connection table. Then, the access point provides, addressed to the computer system, second information specifying the electronic device. Moreover, when a time interval elapses without communication between the electronic device and the access point, the access point deletes the information from the connection table. Next, the access point receives, associated with the electronic device, an orphan notification. Furthermore, the access point provides, addressed to the computer system, a notification message associated with an orphan notification of the electronic device. Additionally, the access point selectively receives, associated with the computer system, third information specifying the electronic device. Based on the third information, the access point stores the third information specifying the electronic device in the connection table and automatically reestablishes the connection with the electronic device.

Note that the information, the second information and/or the third information may include the identifier of the electronic device. For example, the identifier may include the MAC address of the electronic device.

Another embodiment provides the second access point. The second access point includes: an interface circuit that communicates with the electronic device and the computer system; a processor; and memory that stores program instructions. During operation, the second access point receives, associated with the electronic device, an orphan notification. In response, the second access point provides, addressed to the computer system, a notification message, where the notification message is associated with the orphan notification of the electronic device

Another embodiment provides a computer-readable storage medium for use with the access point, the second access point or the computer system. This computer-readable storage medium may include program instructions that, when executed by the access point, the second access point or the computer system, cause the access point, the second access point or the computer system to perform at least some of the aforementioned operations or counterpart operations.

Another embodiment provides a method. This method includes at least some of the operations or counterpart operations performed by the access point, the second access point or the computer system.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for facilitating automatic recovery of a connection between an electronic device and an access point using a computer system in FIG. 1 in accordance with an embodiment of the present disclosure.

FIG. 3 is a flow diagram illustrating an example method for automatically recovering a connection between an electronic device and an access point using an access point in FIG. 1 in accordance with an embodiment of the present disclosure.

FIG. 4 is a flow diagram illustrating an example method for automatically recovering a connection between an electronic device and an access point using the access point in FIG. 1 in accordance with an embodiment of the present disclosure.

FIG. 5 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system (such as a controller) that facilitates automatic recovery of a connection between an electronic device and an access point is described. During operation, the computer system may receive, from the access point, information specifying the electronic device that has the connection with the access point. Then, based at least in part on the information, the computer system may store a mapping between the electronic device and the access point. Moreover, the computer system may receive, from the access point or a second access point, a notification message, where the notification message is associated with an orphan notification of the electronic device. Next, in response to receiving the notification message, the computer system may perform a look-up operation for the electronic device in the stored mapping. Furthermore, when the electronic device is included in the stored mapping, the computer system may selectively provide, to the access point and based at least in part on the stored mapping, second information specifying the electronic device.

By selectively providing the second information, these communication techniques may allow the access point to automatically recover the connection table. For example, the connection table may be recovered even when communication between the electronic device and the access point has been lost for more than a time interval (such as 12 days) and, thus, when the connection between the electronic device and the access point has been lost. Moreover, the communication techniques may allow the access point to automatically reestablish a connection between the access point and the electronic device, which may allow the electronic device to automatically join a network that includes the access point. Consequently, the communication techniques may reduce the complexity and expense of the IoT, which may also reduce user frustration and may, thus, may increase market traction of the IoT.

In the discussion that follows, electronic devices or components in a system communicate packets in accordance with a wireless communication protocol, such as: a wireless communication protocol that is compatible with an Institute of Electrical and Electronics Engineers (IEEE) 802.11 standard (which is sometimes referred to as ‘Wi-Fi®,’ from the Wi-Fi Alliance of Austin, Texas), Bluetooth, ZigBee, Z-Wave (from Sigma Designs, Inc. of Fremont, California), LoRaWAN (from the Lora Alliance of Beaverton, Oregon), Thread (from the Thread Group of San Ramon, California), IPv6 over low-power wireless personal area networks or 6LoWPAN (from the Internet Engineering Taskforce of Fremont, California), a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard, Message Queueing Telemetry Transport (MQTT) and/or another type of wired interface. However, a wide variety of communication protocols may be used in the system, including wired and/or wireless communication. In the discussion that follows, Zigbee and Ethernet are used as illustrative examples.

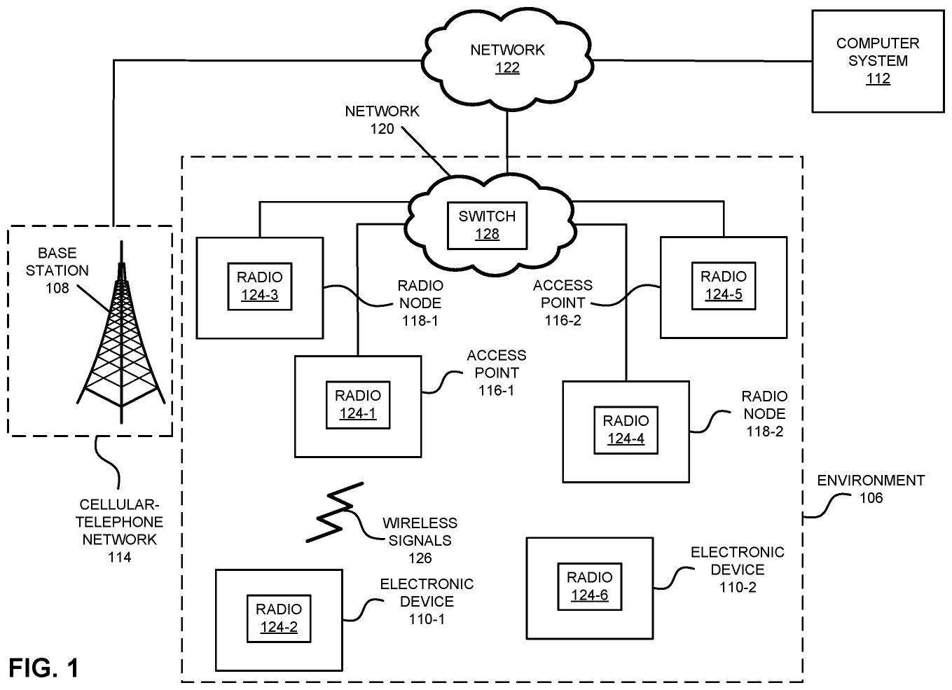

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi or in personal area networks or PANs using Zigbee) and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a PAN, a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or computer system 112 (which may include one or more computers, and which may be a local or cloud-based controller that manages and/or configures access points 116, radio nodes 118 and/or switch 128, or a cloud-based computer system that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

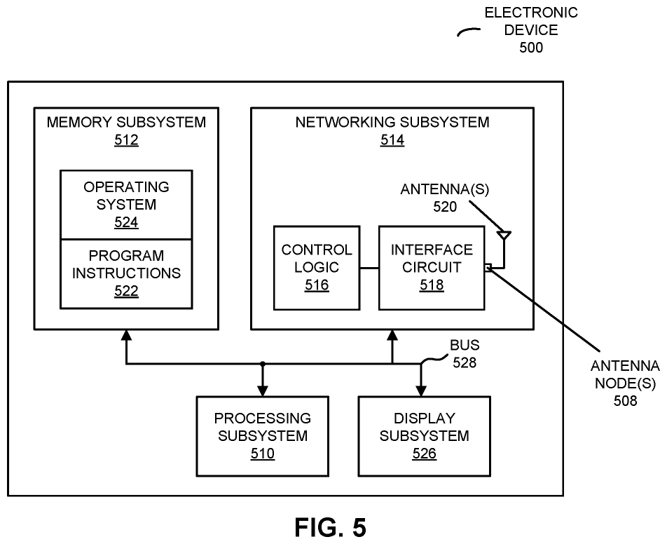

As described further below with reference to FIG. 5, electronic devices 110, computer system 112, access points 116, radio nodes 118 and switch 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple input, multiple output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, one or more electronic devices 110 that have connections with one or more of access points 116 may be subsequently dropped or deleted. When this occurs, it may be necessary for a network administrator with privileges to manually restore the connections. This is time-consuming, expensive and cumbersome.

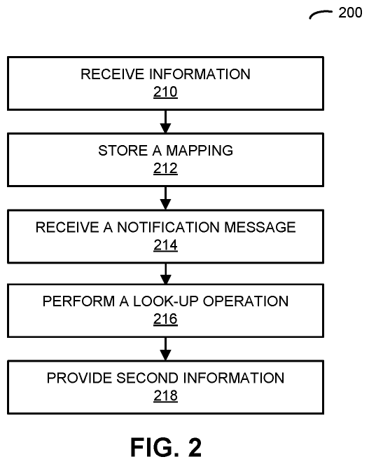

In order to address these problems, as described below with reference to FIGS. 2-4, computer system 112 and/or one or more of access points 116 (such as access point 116-1) may perform the communication techniques. Notably, a connection may be established between an electronic device (such as electronic device 110-1) and access point 116-1. For example, electronic device 110-1 may be an electronic lock and a network administrator with appropriate privileges may authorized the connection being established. Moreover, when establishing the connection, electronic device 110-1 and access point 116-1 may communicate wireless using a Zigbee communication protocol (or a communication protocol that is compatible with Zigbee). Note that the connection may allow electronic device 110-1 to join a network (such as a PAN) that includes access point 116-1.

After the connection is established, access point 116-1 may store information specifying electronic device 110-1 that has the connection with access point 116-1 in a child or a connection table (e.g., in memory in access point 116-1). Moreover, access point 116-1 may provide, to computer system 112, the information specifying electronic device 110-1 that has the connection with access point 116-1. Based at least in part on the information, computer system 112 may store a mapping between electronic device 110-1 and access point 116-1 (e.g., in memory in or associated with computer system 112).

In order to conserve power, electronic device 110-1 may only occasionally communicate with access point 116-1. For example, electronic device 110-1 may transition to a sleep mode and may occasionally transition back to a normal mode to communicate (e.g., using the Zigbee communication protocol) with access point 116-1.

When electronic device 110-1 is unable to communicate with access point 116-1 for more than a time interval (such as 2-3 hrs.), electronic device 110-1 may send or provide an instance of an orphan notification. When access point 116-1 receives an instance of the orphan notification, access point 116-1 may perform a look-up operation for electronic device 110-1 in the stored child or connection table (e.g., based at least in part on an identifier of electronic device 110-1, such as a MAC address of electronic device 110-1). Moreover, when there is a match, access point 116-1 may reestablish the connection with electronic device 110-1.

Furthermore, when access point 116-1 does not communicate with electronic device 110-1 for more than a second time interval (such as 12 days), access point 116-1 may delete electronic device 110-1 from the child or connection table. For example, when a battery failure occurs, electronic device 110-1 may not be able to communicate with access point 116-1. If this loss of power lasts more than 12 days, using existing communication techniques, electronic device 110 may not be able to automatically rejoin the network even when communication with access point 116-1 is restored, such as after a technician replaces the battery in the electronic device 110-1. Indeed, in the existing communication techniques, because the technician does not have privileges, the network administrator may need to also return to a location of electronic device 110-1 to manually rejoin or connect electronic device 110-1 and access point 116-1.

The disclosed communication techniques may address these problems via computer system 112. Notably, after electronic device 110-1 is able to communicate again (such as when the battery is replaced), electronic device 110-1 may send or provide an instance of the orphan message. When the instance of the orphan message is received by access point 116-1, access point 116-1 may perform a look-up operation for electronic device 110-1 in the stored child or connection table. Because there is no match (access point 116-1 has deleted electronic device 110-1 from the child or connection table), access point 116-1 may provide a notification message to computer system 112, where the notification message is associated with the orphan notification of electronic device 110-1 (e.g., the notification message may indicate that access point 116-1 received an orphan message from electronic device 110-1). Alternatively or additionally, when the instance of the orphan message is received by another access point (such as access point 116-2), access point 116-2 may perform a look-up operation for electronic device 110-1 in a stored child or connection table in access point 116-2. Because there is no match (access point 116-2 does not have electronic device 110-1 in its child or connection table), access point 116-2 may provide a notification message to computer system 112, where the notification message is associated with the orphan notification of electronic device 110-1 (e.g., the notification message may indicate that access point 116-2 received an orphan message from electronic device 110-1).

After receiving the notification message(s) from access point 116-1 and/or access point 116-2, computer system 112 may perform a look-up operation for electronic device 110-1 in the stored mapping. For example, the look-up operation may be based at least in part on an identifier of electronic device 110-1, such as a MAC address of electronic device 110-1. Because of the information previously received from access point 116-1 (which is included in the stored mapping), a match may occur for access point 116-1 (and not for access point 116-2).

Therefore, when the match occurs (i.e., electronic device 110-1 is included in the stored mapping), computer system 112 may selectively provide, to access point 116-1 and based at least in part on the stored mapping, second information specifying electronic device 110-1 (such as the identifier of electronic device 110-1). Moreover, based at least in part on the second information, access point 116-1 may automatically reestablish the connection with electronic device 110-1 (e.g., in response to the current or a subsequent orphan notification received from electronic device 110-1). In addition, access point 116-1 may store the second information specifying electronic device 110-1 that has the connection with access point 116-1 in the child or a connection table (e.g., in memory in access point 116-1).

In these ways, the communication techniques may facilitate automatic recovery of a connection between electronic device 110-1 and access point 116-1, which may reduce the cost and complexity of the IoT. Consequently, the communication techniques may provide an improved user experience and may encourage adoption of the IoT.

In the described embodiments, processing a frame or a packet in a given one of the one or more access points 116 or a given one of the one or more electronic devices 110 may include: receiving wireless signals 126 with the frame or packet; decoding/extracting the frame or packet from the received wireless signals 126 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components. Therefore, in some embodiments there may be fewer or additional instances of at least some of the one or more access points 116, the one or more electronic devices 110 and/or computer system 112. As another example, in another embodiment, different electronic devices are transmitting and/or receiving frames or packets.

While the preceding discussion illustrated the communication techniques using a Zigbee communication protocol, in other embodiments a wide variety of communication protocols may be used. Moreover, while the communication techniques were illustrated using a centralized computer system 112, in other embodiments there may be multiple computer systems that are geographically distributed. Alternatively, in some embodiments, a neighboring access point (within wireless range) may perform at least some of the operations in the communication techniques. Consequently, the communication techniques may be implemented in a centralized or a distributed manner. Furthermore, while the preceding discussion illustrated the communication techniques to address loss or deletion of electronic device 110-1 from the child or connection table when there is a battery failure, more generally there are a wide variety of reasons for loss or deletion of electronic device 110-1 from the child or connection table (which are described further below).

We now describe embodiments of the method. FIG. 2 presents an example of a flow diagram illustrating an example method 200 for facilitating automatic recovery of a connection between an electronic device and an access point, which may be performed by a computer system, such as computer system 112 in FIG. 1.

During operation, the computer system may receive, associated with the access point, information (operation 210) specifying the electronic device that has the connection with the access point. Then, based at least in part on the information, the computer system may store a mapping (operation 212) between the electronic device and the access point. Moreover, the computer system may receive, associated with the access point or a second access point, a notification message (operation 214), where the notification message is associated with an orphan notification of the electronic device. Next, in response to receiving the notification message, the computer system may perform a look-up operation (operation 216) for the electronic device in the stored mapping. Furthermore, when the electronic device is included in the stored mapping, the computer system may selectively provide, addressed to the access point and based at least in part on the stored mapping, second information (operation 218) specifying the electronic device.

Note that the information and/or the second information may include an identifier of the electronic device. For example, the identifier may include a MAC address of the electronic device.

Moreover, the orphan notification may occur when the electronic device and the access point are unable to automatically establish the connection. In some embodiments, the orphan notification may be associated with a Zigbee communication protocol.

Furthermore, the connection may allow the electronic device to join a network that includes the access point.

Additionally, the computer system may include a cloud-based computer system. In some embodiments, the computer system may include a controller of the access point.

Note that the electronic device may include an electronic lock.

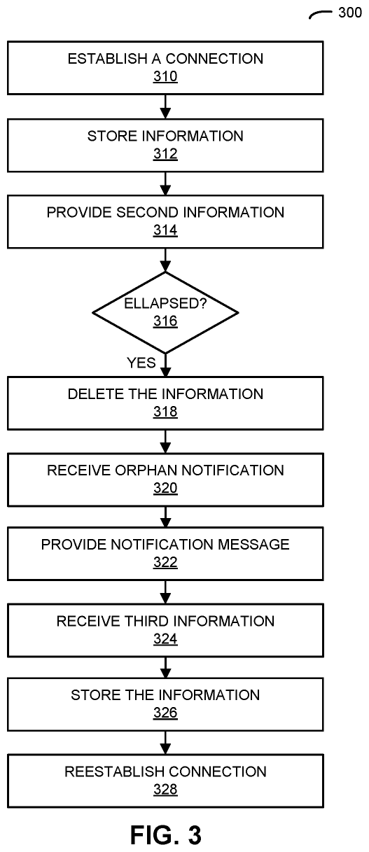

FIG. 3 presents an example of a flow diagram illustrating an example method 300 for automatically recovering a connection between an electronic device and an access point, which may be performed by the access point, such as access point 116-1 in FIG. 1.

During operation, the access point may establish a connection (operation 310) with the electronic device and stores information (operation 312) specifying the electronic device in a connection table. Then, the access point may provide, addressed to the computer system, second information (operation 314) specifying the electronic device. Moreover, when a time interval elapses (operation 316) without communication between the electronic device and the access point, the access point may delete the information (operation 318) from the connection table. Next, the access point may receive, associated with the electronic device, an orphan notification (operation 320). Furthermore, the access point may provide, addressed to the computer system, a notification message (operation 322) associated with an orphan notification of the electronic device. Additionally, the access point may selectively receive, associated with the computer system, third information (operation 324) specifying the electronic device. Based on the third information, the access point may store the third information (operation 326) specifying the electronic device in the connection table and may automatically reestablish the connection (operation 328) with the electronic device.

Note that the information, the second information and/or the third information may include the identifier of the electronic device. For example, the identifier may include the MAC address of the electronic device.

In some embodiments of methods 200 (FIG. 2) and/or 300, there may be additional or fewer operations. Moreover, there may be different operations. Furthermore, the order of the operations may be changed, and/or two or more operations may be combined into a single operation.

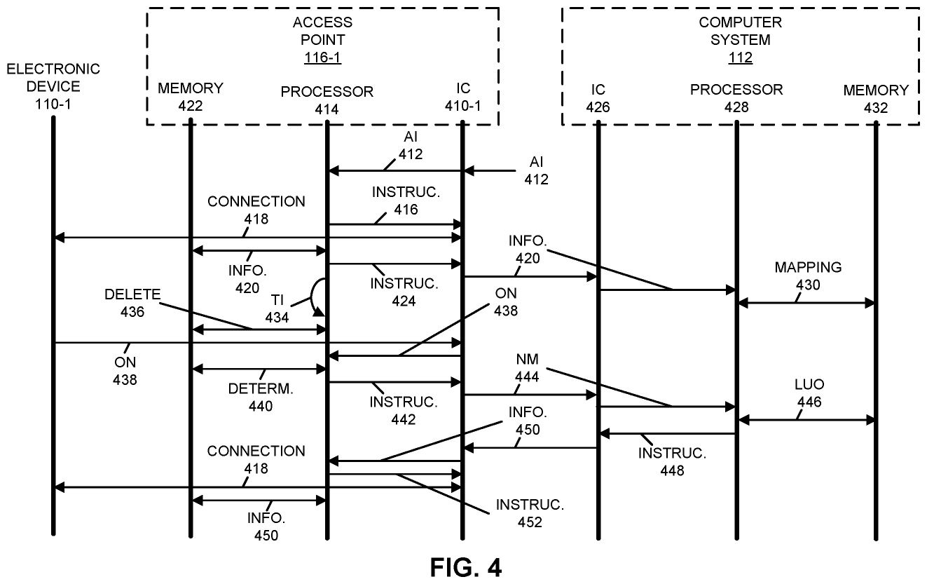

FIG. 4 presents a drawing illustrating an example of communication between electronic device 110-1, access point 116-1 and computer system 112. In FIG. 4, an interface circuit (IC) 410 in access point 116-1 may receive authorization information (AI) 412 from a network administrator (e.g., from an electronic device associated with the network administrator, which is not shown). This authorization information may be provided to processor 414 in access point 116-1, which may instruct 416 interface circuit 410 to establish a connection 418 with electronic device 110-1, e.g., using a Zigbee communication protocol. Moreover, processor 414 may store information 420 about connection 418 with electronic device 110-1 in a child or connection table in memory 422 in access point 116-1. Then, processor 414 may instruct 424 interface circuit 410 to provide information 420 to computer system 112.

After receiving information 420, an interface circuit 426 in computer system 112 may provide information 420 to processor 428 in computer system 112. In response, processor 428 may store a mapping 430 between electronic device 110-1 and access point 116-1 in memory 432 in computer system 112.

When access point 116-1 has not communicated with electronic device 110-1 for more than a time interval (TI) 434, processor 414 may delete 436 information 420 from the child or connection table in memory 422. Subsequently, electronic device 110-1 may provide an orphan notification (ON) 438, e.g., to access point 116-1. After receiving orphan notification 438, interface circuit 410 may provide orphan notification 438 to processor 414. This orphan notification may, directly or indirectly, indicate that electronic device 110-1 is unable to reestablish connection 418 with access point 116-1. In response to orphan notification 438, processor 414 determine 440 that information 420 about electronic device 110-1 is not stored in the child or connection table in memory 422. Consequently, processor 414 may instruct 442 interface circuit 410 to provide notification message (NM) 444 to computer system 112, where notification message 444 may be associated with orphan notification 438.

After receiving notification message 444, interface circuit 426 may provide notification message 444 to processor 428. In response, processor 428 may perform a look-up operation (LUO) 446 for electronic device 110-1 in stored mapping 430 in memory 432. When there is a match, processor 428 may instruct 448 interface circuit 426 to provide information 450 specifying electronic device 110-1 to access point 116-1.

After receiving information 450, interface circuit 410 may provide information 450 to processor 414. In response, processor 414 may instruct 452 interface circuit 410 to automatically reestablish connection 418 with electronic device 110-1. Moreover, processor 414 may store information 450 about connection 418 with electronic device 110-1 in the child or connection table in memory 422.

While FIG. 4 illustrates some operations using unilateral or bilateral communication (which are, respectively, represented by one-sided and two-sided arrows), in general a given operation in FIGS. 4 may involve unilateral or bilateral communication. Moreover, while FIGS. 4 illustrates operations being performed sequentially or at different times, in other embodiments at least some of these operations may, at least in part, be performed concurrently or in parallel.

We now further describe the communication techniques. The communication techniques may allow, in a Zigbee PAN, an access point to discover and establish communication with an electronic device that is removed from a child or a connected devices or connection table of the access point. Notably, a centralized controller (such as an IoT controller) may facilitate automatic reestablishing of a connection between the electronic device and the access point, thereby allowing the electronic device to join a network that includes the access point. Note that the electronic devices in the Zigbee PAN and their identification details and/or authentication details may be known to the controller.

The electronic device that joins a Zigbee PAN created by the access point (which is sometimes referred to as a ‘coordinator’) may be referred to as an ‘end device.’ When the end device is powered by a battery, it may be referred to as a ‘sleepy end device,’ because it may often be in a sleep mode to conserve battery power.

Sleepy end devices may be disconnected from the network because of various factors, such as: radio-frequency interference, a drained or dead battery, or a factory reset of end device or the access point. When the end device is not connected to the network, it may usually be sleeping in order to conserve battery power. The end device may wake up occasionally to attempt to reconnect or reestablish the connection with the access point. Notably, end devices that are already part of the child or connection table may send a rejoin request and the access point may respond to a rejoin request by allowing the end device to rejoin the network.

However, there may be scenarios where the end device is not included in the child or connection table, e.g., because the electronic device has been deleted from the child or connection table because of: a lack of response from the end device, a PAN reset on the access point, the end device or the access point has been replaced with another end device or access point when a hardware error occurs, etc.

When this occurs, the end device may send an orphan notification and one or more nearby access points, which are listening for orphan notifications, may receive the orphan notification. The received orphan notification requests may be forwarded to the controller. In response, the controller may check to see if the end-device MAC address is in a stored data structure or mapping (and, thus, whether the end device is supposed to join in a PAN provided by the access point. If yes, the controller may inform the access point and, in response, a trust center in the access point may add the end device to the child or connection table. If not, the rejoin request may be dropped without further processing.

Then, the next time the end device wakes up and sends a rejoin request, the end device may be included in the child or the connection table and the access point may respond to the rejoin request asking the end device to rejoin. Consequently, the communication techniques may allow the end device, which was supposed to be in the child or connection table but was deleted for some reason, to be automatically recovered without manual intervention at the end device (such as a network administrator putting the end device into a pairing mode). Therefore, the communication techniques may eliminate a need for the network administrator or operator to physically access the end device, thereby reducing the time, cost and complexity of operating the end device and the PAN.

We now describe embodiments of an electronic device, which may perform at least some of the operations in the communication techniques. FIG. 5 presents a block diagram illustrating an example of an electronic device 500 in accordance with some embodiments, such as one of: base station 108, one of electronic devices 110, computer system 112, one of access points 116, one of radio nodes 118, and/or switch 128. This electronic device includes processing subsystem 510, memory subsystem 512, and networking subsystem 514. Processing subsystem 510 includes one or more devices configured to perform computational operations. For example, processing subsystem 510 can include one or more microprocessors, ASICs, microcontrollers, programmable-logic devices, graphical processor units (GPUs) and/or one or more digital signal processors (DSPs).

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory (which collectively or individually are sometimes referred to as a ‘computer-readable storage medium’). In some embodiments, instructions for processing subsystem 510 in memory subsystem 512 include: one or more program modules or sets of instructions (such as program instructions 522 or operating system 524), which may be executed by processing subsystem 510. Note that the one or more computer programs may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments electronic device 500 includes one or more nodes, such as nodes 508, e.g., an antenna node, a connector or a pad, which can be coupled to the one or more antennas 520. Thus, electronic device 500 may or may not include the one or more antennas 520.) For example, networking subsystem 514 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), a ZigBee networking system, a Z-Wave networking system, a LoRaWAN networking system, an Ethernet networking system, and/or another networking system.

In some embodiments, a transmit antenna radiation pattern of electronic device 500 may be adapted or changed using pattern shapers (such as reflectors) in one or more antennas 520 (or antenna elements), which can be independently and selectively electrically coupled to ground to steer the transmit antenna radiation pattern in different directions. Thus, if one or more antennas 520 includes N antenna-radiation-pattern shapers, the one or more antennas 520 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk. Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting frames and/or scanning for frames transmitted by other electronic devices.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Electronic device 500 can be (or can be included in) any electronic device with at least one network interface. For example, electronic device 500 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. Also, although separate subsystems are shown in FIG. 5, in some embodiments some or all of a given subsystem or component can be integrated into one or more of the other subsystems or component(s) in electronic device 500. For example, in some embodiments program instructions 522 are included in operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 514. The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (c.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 522, operating system 524 (such as a driver for interface circuit 518) or in firmware in interface circuit 518. Alternatively or additionally, at least some of the operations in the communication techniques may be implemented in a physical layer, such as hardware in interface circuit 518.

Additionally, while the preceding embodiments illustrated the use of wireless signals in one or more bands of frequencies, in other embodiments of these signals may be communicated in one or more bands of frequencies, including: a microwave frequency band, a radar frequency band, 900 MHz, 2.4 GHz, 5 GHz, 6 GHz, 7 GHz, 60 GHz, and/or a band of frequencies used by a Citizens Broadband Radio Service or by LTE. In some embodiments, the communication between electronic devices uses multi-user transmission (such as OFDMA).

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the communication techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an access point;
a processor; and
memory that stores program instructions, wherein, when executed by the processor, the program instructions cause the computer system to perform operations comprising:
receiving, associated with the access point, information specifying an electronic device that has a connection with the access point;
based at least in part on the information, storing a mapping between the electronic device and the access point;
receiving, associated with the access point or a second access point, a notification message, wherein the notification message is associated with an orphan notification of the electronic device;
in response to receiving the notification message, performing a look-up operation for the electronic device in the stored mapping; and
when the electronic device is included in the stored mapping, selectively providing, addressed to the access point and based at least in part on the stored mapping, second information specifying the electronic device.

2. The computer system of claim 1, wherein the information, the second information, or both comprises an identifier of the electronic device.

3. The computer system of claim 2, wherein the identifier comprises a media access control (MAC) address of the electronic device.

4. The computer system of claim 1, wherein the orphan notification occurs when the electronic device and the access point are unable to automatically establish the connection.

5. The computer system of claim 1, wherein the connection allows the electronic device to join a network that comprises the access point.

6. The computer system of claim 1, wherein the computer system comprises a cloud-based computer system.

7. The computer system of claim 1, wherein the computer system comprises a controller of the access point.

8. The computer system of claim 1, wherein the orphan notification is associated with a Zigbee communication protocol.

9. The computer system of claim 1, wherein the electronic device comprises an electronic lock.

10. A non-transitory computer-readable storage medium for use in conjunction with a computer system, the computer-readable storage medium storing program instructions, wherein, when executed by the computer system, the program instructions cause the computer system to perform operations comprising:
receiving, associated with an access point, information specifying an electronic device that has a connection with the access point;
based at least in part on the information, storing a mapping between the electronic device and the access point;
receiving, associated with the access point or a second access point, a notification message, wherein the notification message is associated with an orphan notification of the electronic device;
in response to receiving the notification message, performing a look-up operation for the electronic device in the stored mapping; and
when the electronic device is included in the stored mapping, selectively providing, addressed to the access point and based at least in part on the stored mapping, second information specifying the electronic device.

11. The non-transitory computer-readable storage medium of claim 10, wherein the information, the second information, or both comprises an identifier of the electronic device.

12. The non-transitory computer-readable storage medium of claim 11, wherein the identifier comprises a media access control (MAC) address of the electronic device.

13. The non-transitory computer-readable storage medium of claim 10, wherein the orphan notification occurs when the electronic device and the access point are unable to automatically establish the connection.

14. The non-transitory computer-readable storage medium of claim 10, wherein the orphan notification is associated with a Zigbee communication protocol.

15. A method for facilitating automatic recovery of a connection between an electronic device and an access point, comprising:
by a computer system:
receiving, associated with the access point, information specifying the electronic device that has the connection with the access point;
based at least in part on the information, storing a mapping between the electronic device and the access point;
receiving, associated with the access point or a second access point, a notification message, wherein the notification message is associated with an orphan notification of the electronic device;
in response to receiving the notification message, performing a look-up operation for the electronic device in the stored mapping; and
when the electronic device is included in the stored mapping, selectively providing, addressed to the access point and based at least in part on the stored mapping, second information specifying the electronic device.

16. The method of claim 15, wherein the information, the second information, or both comprises an identifier of the electronic device.

17. The method of claim 16, wherein the identifier comprises a media access control (MAC) address of the electronic device.

18. The method of claim 15, wherein the orphan notification occurs when the electronic device and the access point are unable to automatically establish the connection.

19. The method of claim 15, wherein the orphan notification is associated with a Zigbee communication protocol.

20. The method of claim 15. wherein the computer system comprises a controller of the access point.
